(19) United States
(12) Patent Application Publication
(10) Pub. No.: US 2024/0400161 A1
(43) Pub. Date: Dec. 5, 2024

(54) ELEVATION SYSTEM AND VESSEL HAVING A SAME

(71) Applicant: DAELYUN ENGINEERING CO., LTD., Busan (KR)

(72) Inventors: AN JIN PARK, Busan (KR); SUNG YUN JEONG, Ulsan (KR); JANG IK PARK, Busan (KR); JONG CHUL OH, Gyeongsangnam-do (KR)

(21) Appl. No.: 18/653,037

(22) Filed: May 2, 2024

(30) Foreign Application Priority Data
May 31, 2023 (KR) 10-2023-0070031

(51) Int. Cl. B63B 25/00; A47B 57/06; B63B 27/00

(52) U.S. Cl. CPC B63B 25/002; A47B 57/06; B63B 27/19

(57) ABSTRACT

An elevation system includes deck units each including a frame, a movable deck coupled to the frame to be movable in a vertical direction, a sliding unit coupled to the frame to be movable in a horizontal direction, and elevation wires connected to the movable deck and the sliding unit via a direction changing sheave at the frame, a first sheave at each of the deck units and fixed to the frame, a second sheave at each of the deck units and coupled to the sliding unit to adjust a distance between the first sheave and the second sheave, a drive wire extending through the deck units and simultaneously wound around the first sheave and the second sheave of each of the deck units to deliver a driving force to the sliding unit, and a driver pulling the drive wire to cause the sliding unit to be slidably moved.

### CROSS-REFERENCE TO RELATED APPLICATION AND CLAIM OF PRIORITY

This application claims the benefit under 35 USC § 119 of Korean Patent Application No. 10-2023-0070031, filed on May 31, 2023, in the Korean Intellectual Property Office, the entire disclosure of which is incorporated herein by reference for all purposes.

### BACKGROUND

### 1. Field of the Invention

The present disclosure relates to an elevation system usable for loading a vehicle or the like and a vessel including the same, and more particularly, to an elevation system capable of selectively driving a plurality of decks or driving them at once and to a vessel including the same.

### 2. Description of the Related Art

A dedicated facility may be used in order to load or unload vehicles on or from a vessel. Among vessels specialized in transporting vehicles, a vessel called a roll-on roll-off vessel (ro-ro vessel) refers to a kind of cargo vessel for carrying general vehicles, trucks, trailers, and the like. Since vehicles can maneuver by themselves, this ro-ro vessel is characterized in that vehicles can be directly loaded on or unloaded from the vessel by driving the vehicles without using a separate crane.

The ro-ro vessel has a structure configured to load (roll-on) or unload (roll-off) vehicles with self-moving capability onto or from the vessel through a ramp directly or by being loaded on a transportation vehicle such as a truck or trailer through a ramp. However, since vehicles loaded on the vessel vary from passenger cars to medium- and large-sized heavy equipment, it is necessary to increase the amount of shipment by making good use of space in the cargo hold.

For example, since a passenger car has a lower overall vehicle height than a mid-to-large-sized heavy equipment, too much space in the cargo hold may become useless. Therefore, conventionally, a method such as installing a separate lift device (mobile deck lifter or deck hoisting system) in the cargo hold and loading passenger cars in multiple stages has been used to increase the loading capacity of passenger cars (e.g., Korean Patent No. 10-2316013 and the like).

However, most of the conventional lifting devices have a problem in that a lot of load is burdened to the drive system, and the fixing structure is complicated, which results in an inefficient drive. In addition, there is also a problem in that it is difficult to apply the lifting devices depending on the size of the vessel because their volumes and thus their installation spaces are large. Since these problems have not been adequately addressed, there is a need for an alternative.

Meanwhile, there are many cases of installing a parking tower to make good use of a narrow parking space such as in a building or the like. However, in a space where it is difficult to install a parking tower, it is necessary to divide one floor to utilize it as multiple floors.

Additionally, it is necessary to use, in a variable manner, a loading space in a warehouse or a loading box of a cargo vehicle for loading goods according to the size of the goods.

### SUMMARY

The present disclosure is conceived to address these problems, and is intended to provide an elevation system that can selectively drive multiple decks or drive them at once in an efficient way with an efficient operating structure, as well as to provide a vessel including the same.

The technical objects of the present disclosure are not limited to the aforementioned ones, and unmentioned other objects thereof will become apparent to those skilled in the art from the description below.

The elevation system according to the present disclosure includes a plurality of deck units, each of which including a frame, a movable deck coupled to the frame so as to be movable in a vertical direction, a sliding unit coupled to the frame so as to be movable in a horizontal direction, a plurality of elevation wires, each of which has one end connected to the movable deck and the other end coupled to the sliding unit via a direction changing sheave installed at the frame; a first sheave installed at each of the deck units and fixed to the frame; a second sheave which is installed at each of the deck units and is coupled to the sliding unit, so that a distance between the first sheave and the second sheave is adjusted as the sliding unit moves; a drive wire which extends through the plurality of deck units and is simultaneously wound around the first sheave and the second sheave of each of the deck units to deliver a driving force to the sliding unit; and a driver which pulls the drive wire to cause the sliding unit to be slidably moved.

The elevation system may further include a fixing unit which is installed at the deck unit and restrains the sliding unit or releases restraint of the sliding unit to selectively cause only the position of the second sheave of at least one of the plurality of deck units to be variable.

The fixing unit may be installed in at least one of the sliding unit and the frame, and when the sliding unit arrives at a fixing position, a part may protrude from the sliding unit or the frame to restrict a movement of the sliding unit.

The fixing unit may include a fixing block which is protruded by a driving apparatus and is inserted into the frame from the sliding unit or is inserted into the sliding unit from the frame, and the driving apparatus may be operated by at least one of hydraulic, electric, and magnetic forces.

The fixing unit may include a drive motor configured to drive a pinion gear, a rack bar meshed with the pinion gear to be linearly moved, and the fixing block connected to the rack bar and configured to be inserted into the frame from the sliding unit or into the sliding unit from the frame.

The first sheave and the second sheave may be arranged so that an imaginary line connecting respective rotational axes thereof is in the same direction as a direction in which the drive wire extends passing through the deck unit.

The drive wire may extend parallel to a moving direction of the sliding unit.

The first sheave and the second sheave may have the same diameter.

The second sheave and the elevation wire may be coupled to both ends of the sliding unit along the imaginary line, respectively, the second sheave may be disposed on an inside facing the first sheave, and the elevation wire may extend to the outside and be connected to the movable deck via the direction changing sheave.

The drive wire may include a first section in which the drive wire comes into any one deck unit from the driver or an adjacent deck unit and contacts any one of the first sheave and the second sheave, a second section in which the drive wire contacts the other one of the first sheave and the second sheave and extends to another adjacent deck unit, and a third section in which the drive wire contacts the first sheave and the second sheave at the same time.

Any one of the first sheave and the second sheave may be arranged to be twisted relative to the other thereof, so that the first section and the second section are at different heights.

At least one of the first sheave and the second sheave may be provided in a multi-layer form by arranging a plurality of sheaves one above another with their axes on the same rotational axis.

The drive wire may be simultaneously wound between the first sheave and the second sheave a plurality of times, and may extend to an adjacent deck unit.

The movable deck of any one of the plurality of deck units may be elevated or the plurality of movable decks of the plurality of deck units may be simultaneously elevated, depending on a number of the second sheaves whose position is variable.

A vessel including the elevation system of the present disclosure may include a hull; and an elevation system installed inside the hull.

### BRIEF DESCRIPTION OF THE DRAWINGS

FIG. 1 is a perspective view showing a part of the elevation system according to an embodiment of the present disclosure;

FIGS. 2A and 2B show a top view and a front view of the elevation system according to an embodiment of the present disclosure;

FIGS. 3A to 3D are a conceptual diagram for explaining a winding configuration of a drive wire and a driving force delivery method of the elevation system of FIGS. 2A and 2B;

FIG. 4 is a perspective view showing the winding configuration and operating method of the drive wire of the elevation system of FIGS. 2A and 2B;

FIG. 5 is an enlarged front view illustrating a winding configuration of a first sheave and a second sheave of the elevation system of FIGS. 2A and 2B;

FIG. 6 shows an enlarged view of the sliding unit of the elevation system of FIGS. 2A and 2B;

FIGS. 7A and 7B are an enlarged top view and a front view of any one deck unit included in the elevation system of FIGS. 2A and 2B;

FIGS. 8A and 8B show operational views of the deck unit of FIGS. 7A and 7B;

FIG. 9 shows a modification of the first sheave and the second sheave;

FIGS. 10A to 11B are operational views of the entire elevation system of FIGS. 2A and 2B; and

FIG. 12 is a conceptual diagram of a vessel including an elevation system according to an embodiment of the present disclosure.

### DETAILED DESCRIPTION OF THE EMBODIMENTS

Advantages and features of the present disclosure, and methods of achieving them will become apparent by referring to the embodiments described below in detail in conjunction with the accompanying drawings. However, the present disclosure is not limited to the embodiments disclosed below, but will be implemented in a variety of different forms. The present embodiments are only provided so that the description of the present disclosure is complete, and to fully inform those of ordinary skill in the art to which the present disclosure pertains of the scope of the disclosure, and the present disclosure is defined only by the claims. Like reference numerals refer to like components throughout the specification.

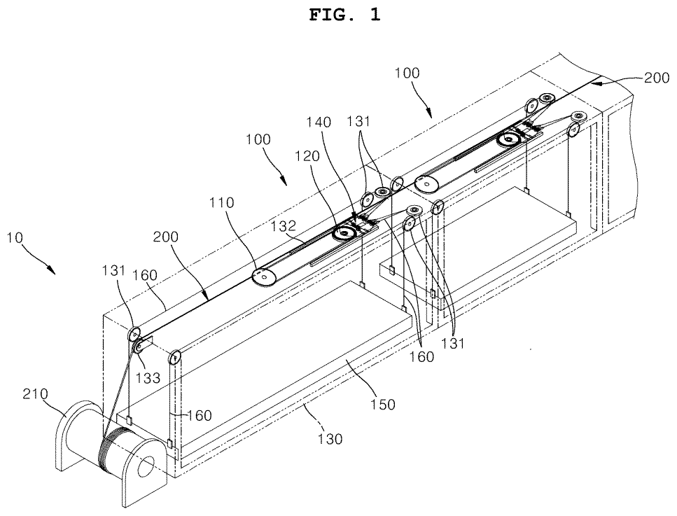

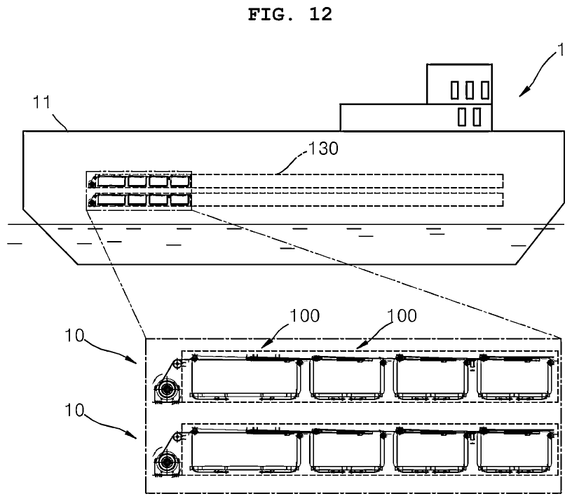

Hereinafter, an elevation system according to the present disclosure and a vessel including the same will be described in detail with reference to FIGS. 1 to 12. First, the elevation system will be described in detail with reference to FIGS. 1 to 11B, and the vessel including the elevation system will also be described in detail with reference to FIG. 12 based thereon.

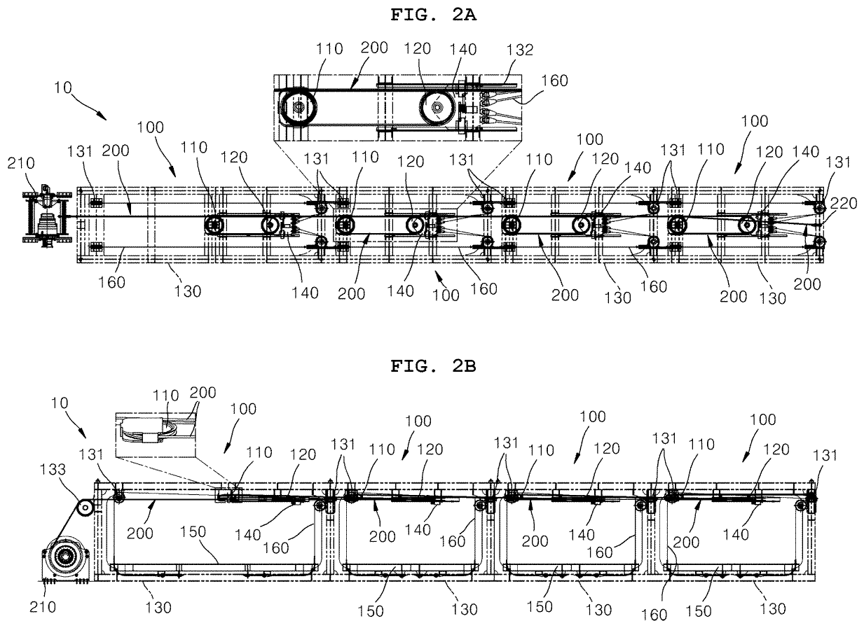

FIG. 1 is a perspective view showing a part of the elevation system according to an embodiment of the present disclosure, and FIGS. 2A and 2B show a top view and a front view of the elevation system according to an embodiment of the present disclosure.

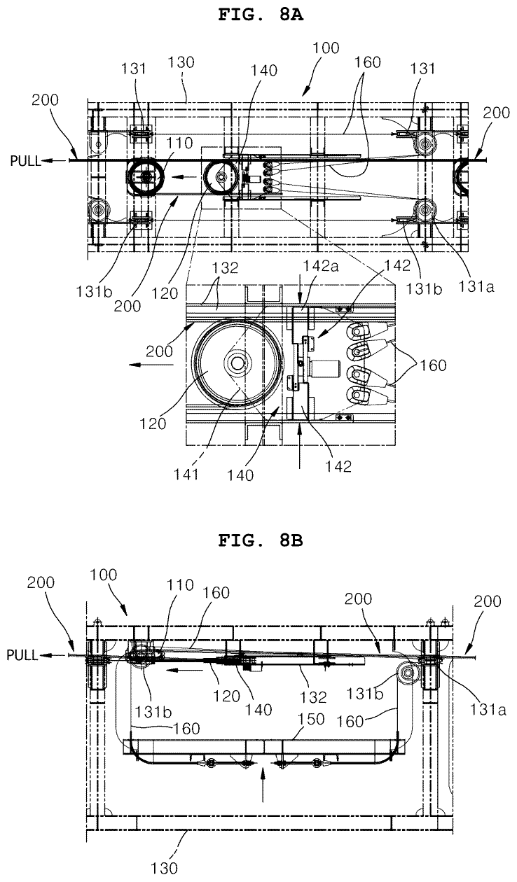

Referring to FIGS. 1 to 2B, the elevation system 10 according to the present disclosure includes a plurality of deck units 100, each of which includes a movable deck 150. Each of the deck units 100 has a substantially identical configuration, and lifts the movable deck 150 by use of a driving force provided from a drive wire 200 (see FIGS. 8A and 8B).

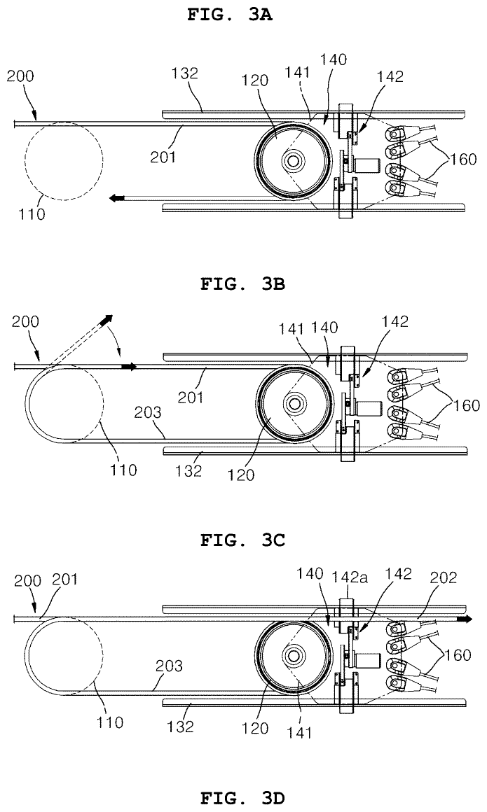

The drive wire 200 extends through each of the deck units 100. However, when the drive wire 200 passes through the plurality of deck units 100, it is arranged in such a way as to be wound simultaneously around a first sheave 110 and a second sheave 120 installed at each of the deck units 100 and exit them. Since the first sheave 110 of each of the deck units 100 is fixed and the second sheave 120 is coupled to the sliding unit 140 to be moved along with it, the second sheave 120 acts like a kind of movable pulley (see FIG. 3D). Therefore, when the second sheave 120 is moved by pulling the drive wire 200, the movable deck 150 can be lifted by use of connection structures (sliding unit and elevation wires) connected to the second sheave.

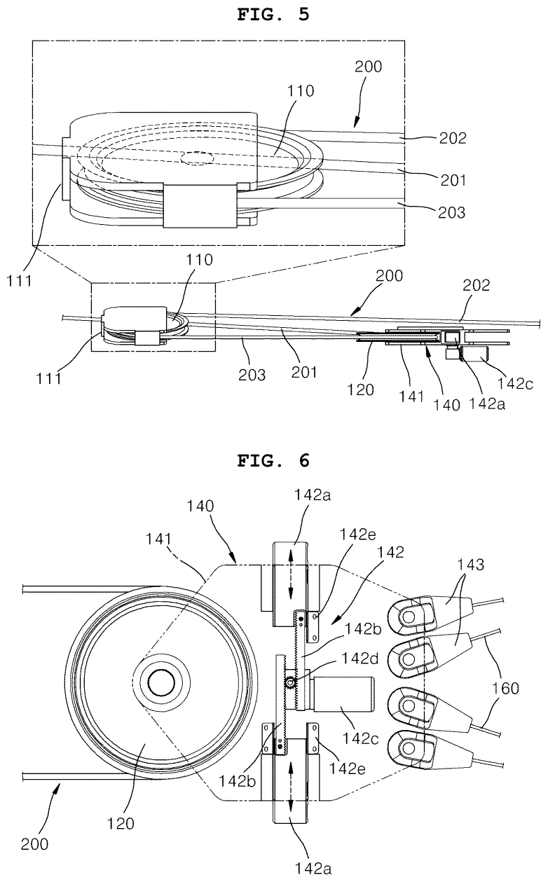

The second sheave 120 and the sliding unit 140 can be selectively restrained or released by use of a fixing unit (see 142 in FIG. 6). Accordingly, only necessary deck unit 100 among the plurality of deck units 100 can be selected and operated, and the plurality of deck units 100 can also be simultaneously operated.

The elevation system 10 of the present disclosure is configured as follows. The elevation system 10 includes a plurality of deck units 100, each of which including a frame 130, the movable deck 150 coupled to the frame 130 so as to be movable in a vertical direction, the sliding unit 140 coupled to the frame 130 so as to be movable in a horizontal direction, a plurality of elevation wires 160 each of which has one end connected to the movable deck 150 and the other end coupled to the sliding unit 140 via a direction changing sheave 131 installed at the frame 130; the first sheave 110 which is installed at each of the deck units 100 and fixed to the frame 130 of each of the deck units 100; the second sheave 120 which is installed at each of the deck units 100 and is coupled to the sliding unit 140 of each of the deck units 100, so that the distance between the first sheave 110 and the second sheave is adjusted as the sliding unit 140 moves; the drive wire 200 that extends through a plurality of deck units 100 and is simultaneously wound around the first sheave 110 and the second sheave 120 of each of the deck units 100 to deliver a driving force to the sliding unit 140; and a driver 210 which pulls the drive wire 200 to cause the sliding unit 140 to be slidably moved.

In an embodiment of the present disclosure, the elevation system 10 may further include the fixing unit (see 142 of FIG. 6) which is installed at the deck unit 100 and restrains or releases restraint of the sliding unit 140 to selectively cause only the position of the second sheave 120 of at least one of the plurality of deck units 100 to be variable. The fixing unit 142 may be installed in at least one of the sliding unit 140 and the frame 130 of each of the deck units 100, and when the sliding unit 140 arrives at a fixing position, a part can protrude from the sliding unit 140 or the frame 130 to restrict the movement of the sliding unit 140.

In this embodiment, an example in which the fixing unit 142 is installed at each of the sliding units 140 is described, but since the fixing unit is for restraining or releasing restraint of the sliding unit 140, it may be installed at the frame side or installed at both the sliding unit side and the frame side. Therefore, the technical idea of the present disclosure is not limited to this embodiment. Hereinafter, the configuration and operational effects of the present disclosure will be described in more detail based on an embodiment of the present disclosure.

Referring to FIGS. 1 to 2B, the deck units 100 is formed in plurality. The number of deck units 100 can be increased or decreased as needed, and thus as many illustrated structures as necessary can be combined to construct the elevation system 10 including a plurality of deck units 100. Additionally, it is also possible to construct a multi-layer structure by arranging such elevation systems 10 one above another. This arrangement will be described in more detail through a vessel (see 1 in FIG. 12) including the elevation system 10 to be described later.

Referring to FIG. 1, one deck unit 100 may include the frame 130, the movable deck 150, the sliding unit 140, and the elevation wire 160. A loading space is formed in the inside of the frame 130, and the movable deck 150 is raised and lowered in the inner space of the frame 130, so the height is changed (see FIGS. 8A and 8B). The elevation wire 160 connects the sliding unit 140 and the movable deck 150 via the direction changing sheave 131 installed at the frame 130. Therefore, when the sliding unit 140 moves, the elevation wire 160 can pull the movable deck 150 to elevate it.

This structure of the deck unit 100 is substantially the same for each of the plurality of deck units 100. Some deck units 100 may be partially modified such as by having a greater loading space than other deck units 100, but the driving configuration is substantially the same. Therefore, with reference to FIG. 1, one deck unit 100 will be described in more detail in terms of the configuration. The description below applies equally to other deck units 100.

Referring to FIG. 1, the frame 130 of the deck unit 100 may be formed as a rectangular frame with an empty interior. In FIG. 1, the frame 130 is not shown in detail to show the internal structure, but its structure is shown as it is in the top view (FIG. 2A) and the front view (FIG. 2B) of FIGS. 2A and 2B. The frame 130 may be, for example, a framework including edges configured in a rectangular shape, and the sides and the like may be open. Reinforcing members may also be arranged on the upper portion, the lower portion, and the like of the frame 130 to reinforce its strength. The frame 130 is not limited to an artificial structure for installing the deck unit 100, and it may be a part of the hull structure when used in a vessel, or it may be a part of the building structure when used as a parking system or a loading system inside a building. That is, the frame 130 can be formed with any structure regardless of its shape or size as long as it can be used for installing the elevation system 10 in a place where the deck unit 100 is to be installed.

The movable deck 150 is coupled to the inside of the frame 130 so as to be movable in a vertical direction. The movable deck 150 may be a planar structure, and, as shown in FIGS. 1 to 2B, may be arranged in a horizontal direction and may be moved (elevated) in parallel in a vertical direction. Although not shown, a guide rail (not shown) for guiding the vertical movement of the movable deck 150 may be installed at the pillar portion or the like of the frame 130 or a locking structure (not shown) or the like for being fixed to the frame 130 by protruding or retracting may be formed on the side of the movable deck 150 as needed. Such structures may be applied as needed.

The sliding unit 140 may be disposed at the upper portion of the frame 130. The sliding unit 140 may be coupled to, for example, a sliding rail 132 installed at the frame 130 in a horizontal direction and be moved along the sliding rail 132. The sliding unit 140 is coupled to the frame 130 to be slidably moved in a horizontal direction. The sliding unit 140 is coupled with the second sheave 120, and serves to form the second sheave 120 into a movable structure (that is, the second sheave is coupled with the sliding unit and is moved as one body). In addition, since it is also connected with the elevation wire 160, when the second sheave 120 is moved, it also serves to pull the elevation wire 160 while being moved together. A specific structure of the sliding unit 140 will be described in more detail below.

Meanwhile, the sliding unit 140 has been described by way of example as a structure disposed at the upper portion of the frame 130 for convenience, but due to the nature of the wire driving method, the sliding unit 140 is not necessarily limited to being disposed at the upper portion of the frame 130. That is, it can be installed at the side, bottom of the frame 130, or at a position somewhat spaced apart from the deck unit 100 as long as the installation location thereof allows the power to be delivered by wire.

In this specification, it should be noted that the body (see 141 of FIG. 6) of the sliding unit 140 is shown with an imaginary line to reveal the internal structure.

Referring to FIG. 1, the elevation wire 160 has one end connected to the movable deck 150 and the other end coupled to the sliding unit 140 via the direction changing sheave 131 installed at the frame 130. The elevation wires are formed in plurality, and they can be connected to the corners of the movable deck 150, respectively. For example, one elevation wire 160 may have one end connected to the movable deck 150 and the other end connected to the rear portion of the sliding unit 140 via at least one direction changing sheave 131. The elevation wire 160 may be bent by the direction changing sheave 131 to change its traveling direction.

The direction changing sheave 131 may be installed at the upper portion of the frame 130. As shown in FIG. 1, the direction changing sheaves 131 may be installed at locations corresponding to the four corners of the movable deck 150, respectively, to allow the elevation wires 160 to be connected to the four corners of the movable deck 150, respectively. The elevation wires 160 connected respectively to the four corners of the movable deck 150 are gathered at the rear portion of the sliding unit 140 via the direction changing sheaves 131 in contact with the elevation wires, and as a result, all of the plurality of elevation wires 160 are connected to one side of the sliding unit 140, so that they can be simultaneously pulled by the movement of the sliding unit 140.

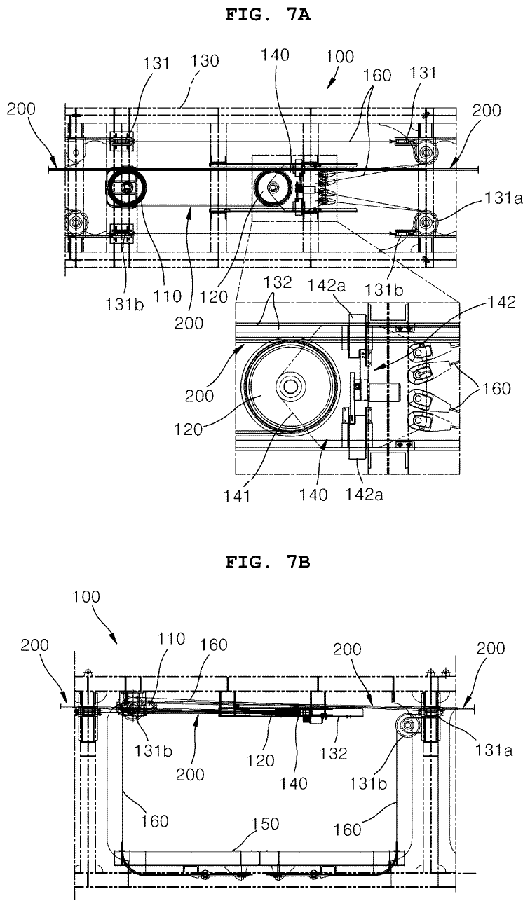

In order to connect the elevation wire 160 between the movable deck 150 and the sliding unit 140 in this way, the direction changing sheave 131 can be modified in various forms. For example, the plurality of elevation wires 160 can be connected from the rear portion of the sliding unit 140 to the corners of the moving deck 150, respectively, by disposing horizontal sheaves (see 131a in FIGS. 7A and 7B) formed in the horizontal direction behind the sliding unit 140 and vertical sheaves (see 131b in FIGS. 7A and 7B) formed in the vertical direction above the four corners of the movable deck 150, and distributing the elevation wires 160 from the horizontal sheaves 131a to the four vertical sheaves 131b.

The direction changing sheave 131 may be formed by combining the horizontal sheave 131a and the vertical sheave 131b, but it is not limited thereto, and in addition, it is possible to form various types of the direction changing sheaves 131, which enable the elevation wire 160 to be connected between the moving deck 150 moving vertically and the sliding unit 140 moving in the horizontal direction by appropriately changing the traveling path of the elevation wire 160.

Since this structure is equally applied to each of the deck units 100, it is understood that other deck units 100 also include the similar structure even if not separately described below. As shown in FIGS. 2A and 2B, the plurality of deck units 100 can be combined to each other by connecting their frames 130, and when the frames 130 of the respective deck units 100 are connected in this way, the frames 130 can be formed integrally with each other. As described above, of course, the frame 130 can be formed by using the structure disposed at the installation site as it is.

The first sheave 110 and the second sheave 120 are installed at each of the deck units 100. FIGS. 2A and 2B show four different deck units 100, and it can be seen that four pairs of the first sheave 110 and second sheave 120 are disposed at each of the deck units 100. When the number of deck units 100 increases, the number of the pairs of the first sheave 110 and sheave 120 second also increases correspondingly. The first sheave 110 and the second sheave 120 are correspondingly disposed at the respective deck unit 100.

The first sheave 110 is fixed to the frame 130 of the deck unit 100, and the second sheave 120 is coupled to the sliding unit 140 of the deck unit 100. Since the sliding unit 140 is movable, the distance between the second sheave 120 and the first sheave 110 is adjusted as the sliding unit 140 moves. That is, although the drive wire 200 is wound around the second sheave 120, since the second sheave 120 is coupled to the sliding unit 140, when the drive wire 200 is pulled, the driving force is substantially delivered to the sliding unit 140 through the second sheave 120. Therefore, when the sliding unit 140 is moved, the elevation wires coupled thereto are pulled. That is, the second sheave 120 may move together with the sliding unit 140, and act as a kind of movable pulley whose distance from the first sheave 110 varies. These first sheave 110 and the second sheave 120 are disposed at each of the deck units 100.

As shown in FIGS. 1 to 2B, the drive wire 200 is arranged to pass through the plurality of deck units 100. The drive wire 200 is simultaneously wound around the first sheave 110 and the second sheave 120 installed at each of the deck units 100 for each of the deck unit 100 and extends to another adjacent deck unit 100. Since the drive wire 200 is wound between the first sheave 110 and the second sheave 120, when the drive wire 200 is pulled, the second sheave 120 can act as a movable pulley, thereby causing the sliding unit 140 to move. That is, the drive wire 200 delivers the driving force to the sliding unit 140 by being simultaneously wound around the first sheave 110 and the second sheave 120 of each of the deck units 100.

In this regard, being simultaneously wound refers to being wound around the two sheaves so that the second sheave 120 can be moved relative to the first sheave 110 with the first sheave 110 as a fixed point. The winding order is not necessarily limited, but for example, it may mean that the wire is simultaneously wound around both sheaves in a manner in which the wire is first wound around the second sheave 120 to be bent, and then is wound around the first sheave 110. The winding configuration will be described in detail later (see FIGS. 3A to 3D).

As shown in FIGS. 2A and 2B, one end of the drive wire 200 is connected to the driver 210 formed outside the deck unit 100, and the other end thereof passes through the plurality of deck units 100, and then can be fixed to the fixed end of the last deck unit 100 (see 220 in FIG. 2A). The driver 210 may be a winch, and the fixed end may be a kind of anchor. However, it is not necessarily limited thereto, and the driver 210 can have different structures capable of pulling the drive wire 200, and for example, in addition to a winch, it may be formed by utilizing a hydraulic cylinder or other traction devices (a structure capable of generating displacement by pulling a drive wire or applying tension through it).

The drive wire 200 between the one end and the other end is pulled into the deck unit through an inlet pulley (see 133 in FIG. 1), and repeats the arrangement in which it is simultaneously wound around the first sheave 110 and the second sheave 120 installed at each of the deck units 100 and extends to another deck unit 100. Hereinafter, the winding configuration of the drive wire 200 will be described in more detail with reference to FIGS. 3A to 5.

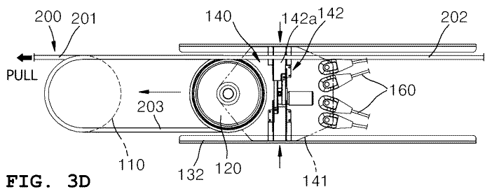

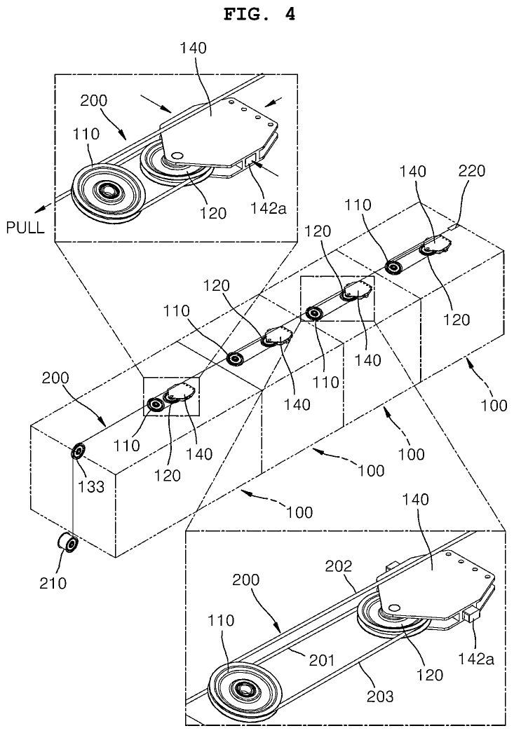

FIGS. 3A to 3D are a conceptual diagram for explaining a winding configuration of a drive wire and a driving force delivery method of the elevation system of FIGS. 2A and 2B, FIG. 4 is a perspective view showing the winding configuration and operating method of the drive wire of the elevation system of FIGS. 2A and 2B, and FIG. 5 is an enlarged front view illustrating a winding configuration of a first sheave and a second sheave of the elevation system of FIGS. 2A and 2B.

FIGS. 3A to 3C illustrate how the drive wire 200 is wound around the sheaves. FIGS. 3A to 3C illustrate a winding order for explaining the winding configuration of the drive wire 200, but this order does not limit the winding method. For example, since the same winding configuration may be implemented in the reverse order of that shown in the drawing, the winding method is merely illustrative and does not need to be limited to the drawing.

Referring to FIGS. 3A to 3D, the first sheave 110 and the second sheave 120 of each of the deck unit (see 100 in FIGS. 2A and 2B) may be spaced apart in a direction in which the sliding unit 140 slides. The second sheave 120 is coupled to the sliding unit 140 and is movable in a direction toward the first sheave 110. In contrast, the first sheave 110 is fixed immovably to the frame (see 130 in FIGS. 2A and 2B).

The drive wire 200 may be wound around each of the sheaves as follows. For example, the drive wire 200 enters one side of the deck unit, is bent once as shown in FIG. 3A and is wound around the second sheave 120, and then, as shown in FIG. 3B, it may be bent again along the first sheave 110 and is wound around the first sheave 110 as well. After being simultaneously wound around the first sheave 110 and the second sheave 120 in this way, it may extend in the entry direction as shown in FIG. 3C and pass past the second sheave 120 to enter the next deck unit.

In this way, since the drive wire 200 is simultaneously wound around both the first sheave 110 and the second sheave 120 (see FIG. 3C), when tension is applied by pulling the drive wire 200 with the driver (see 210 in FIG. 1), the second sheave 120 can be moved towards the fixed first sheave 110 as shown in FIG. 3D. Since the second sheave 120 can be driven while being coupled to the sliding unit 140, when pulling the drive wire 200 in this way, the second sheave can act as a movable pulley whose position is variable.

However, as shown in FIG. 3D, the sliding unit 140 is moved only in a state in which the fixing unit 142 released the restraint of the sliding unit 140 (for example, it can be released by retracting a fixing block 142a), only the second sheave 120 of a desired deck unit can be selectively moved by restraining or releasing the restraint of the sliding unit 140 of a specific deck unit among the plurality of deck units by use of the fixing unit 142.

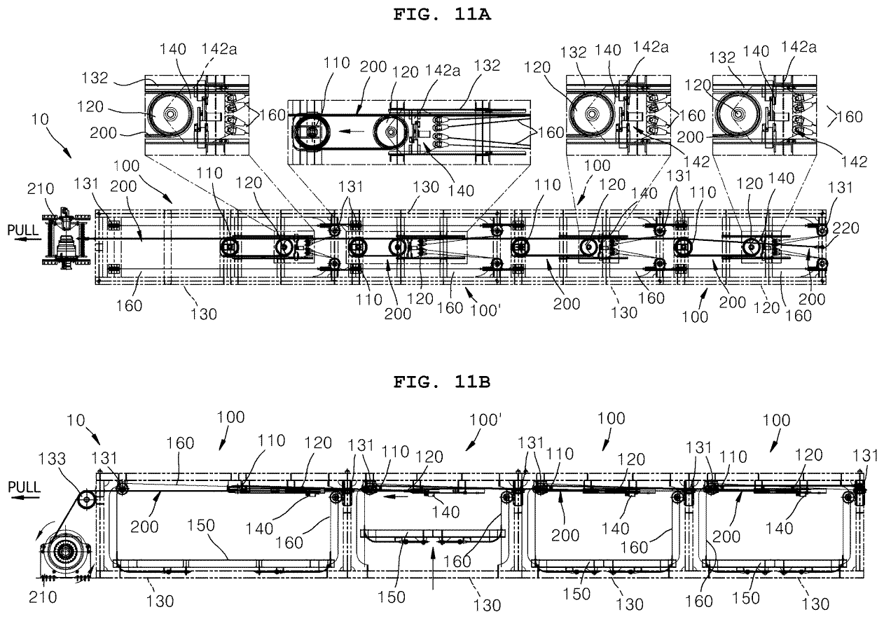

That is, the drive wire 200 is arranged to be simultaneously wound around the first sheave 110 and the second sheave 120 in the manner illustrated in FIGS. 3A to 3C to deliver the driving force to the sliding unit 140 coupled to the second sheave 120, and the fixing unit 142 installed at the deck unit 100 can restrain or release the restraint of the sliding unit 140 so that only the position of the second sheave 120 of at least any one of the plurality of deck units 100 can be selectively changed. With this structure, it is possible to select and operate only a necessary deck unit among the plurality of deck units by pulling the single drive wire 200 (see FIGS. 11A and 11B).

The structure of the fixing unit 142 will be described in more detail below.

Referring to FIG. 4, the drive wire 200 repeats this winding configuration for the plurality of different deck units 100 so that the single drive wire 200 is repeatedly wound around the first sheaves 110 and the second sheaves 120 of all deck units 100. In FIG. 4, in order to clearly show the winding configuration of the drive wire 200, other structures (e.g., the movable deck, the elevation wire, etc.) are omitted, while in the enlarged views, the above-described winding configuration (lower enlarged view) of the drive wire 200 and the movement of the second sheave 120 by pulling the drive wire 200 (upper enlarged view) are shown in perspective view for reference.

Due to this, the drive wire 200 may include, for example, a first section 201 in which the drive wire comes into any one deck unit from the driver 210 or an adjacent deck unit and contacts any one of the first sheave 110 and the second sheave 120, a second section 202 in which the drive wire contacts the other one of the first sheave 110 and the second sheave 120 and extends to another adjacent deck unit, and a third section 203 in which the drive wire contacts the first sheave 110 and the second sheave 120 at the same time.

The first section 201, the second section 202, and the third section 203 may be formed parallel to each other, but may not necessarily be so depending on the arrangement configuration of the sheaves and the sizes of the sheaves. However, it is preferable to keep the first section 201, the second section 202, and the third section 203 as parallel as possible through proper arrangement of the sieves.

Referring to FIGS. 4 and 5, the first sheave 110 may be arranged to be slightly inclined (with the rotational axis being slightly inclined) for the winding configuration of the drive wire 200. To be fixed in an inclined state, the first sheave 110 may be inserted into a fixed sheave housing (see 111 in FIG. 5) which fixes the first sheave with its rotational axis being inclined. For example, the first sheave 110 may be arranged to be inclined so that it avoids the first section 201 in which the drive wire comes in from an adjacent deck unit or the driver 210 and contacts the second sheave 120. In such a case, interference between the drive wire 200 and the second sheave 120 can be eliminated by placing one point of the first sheave 110 having a relatively lower height at a horizontal position with the second sheave 120 and extending the drive wire 200 from the other point of the first sheave 110 having a relatively higher height. That is, as shown, the second section 202, in which the drive wire contacts the first sheave 110 and extends to another adjacent deck unit, can pass above the second sheave 120 by use of the inclination of the first sheave 110. Through proper adjustment of the inclination, the third section 203 in which the drive wire contacts the first sheave 110 and the second sheave 120 at the same time can be maintained horizontally.

That is, any one of the first sheave 110 and the second sheave 120 may be arranged to be twisted relative to the other, so that the first section 201 and the second section 202 may be at different heights. Here, being arranged to be twisted means that the rotational axes of the sheaves are not aligned in parallel to each other, and this state is clearly shown in the enlarged view of FIG. 4. Preferably, for structural stability, the second sheave 120 whose position is variable may be arranged in a horizontal direction, and the first sheave 110 in a fixed state may be arranged in a slightly twisted state.

That is, for the drive wire 200, the first section 201 in which the drive wire comes in from the adjacent deck unit or the driver 210 and contact the second sheave 120 and the second section 202 in which the drive wire contacts the first sheave 110 and extends to another adjacent deck unit can be arranged at different heights by use of the inclination of the first sheave 110, through which interference between the wire sections or between structures and wires can be effectively eliminated. Therefore, although a plurality of sheaves are wound with the single drive wire 200, the intersection between the wires or the intersection with other structures is eliminated, and thus the apparatus can be implemented more effectively.

Hereinafter, the sliding unit and the fixing unit will be described in more detail with reference to FIG. 6.

FIG. 6 shows an enlarged view of the sliding unit of the elevation system of FIGS. 2A and 2B. In this drawing, it should be noted that the body (see 141 of FIGS. 3A to 3C) of the sliding unit 140 is shown with an imaginary line to reveal the internal structure.

Referring to FIG. 6, the sliding unit 140 may include a movable body 141. The body 141 of the sliding unit 140 may be coupled to the sliding rail (see 132 in FIGS. 3A to 3C) installed at the above-described frame (see 130 in FIGS. 1 to 2B) and moved along the sliding rail 132. The body 141 of the sliding unit 140 may be formed with, for example, a structure in which plate bodies arranged in a horizontal direction are combined to each other (see FIG. 5). The body 141 has an accommodation space formed therein so that it can be moved while containing other structures therein.

The second sheave 120 is coupled to the sliding unit 140, and the elevation wires 160 described above are also coupled to the opposite side to the second sheave 120. Thus, the sliding unit 140 also serves as a connection structure connecting the second sheave 120 and the elevation wire 160 to each other. Therefore, when the drive wire 200 delivers a driving force to the sliding unit 140 through the second sheave 120, the sliding unit 140 is moved and pulls the elevation wires 160.

The second sheave 120 and the elevation wire 160 are coupled to both ends of the sliding unit 140 (i.e., both ends of the body 141), respectively, the second sheave 120 is disposed at the inside facing the first sheave (see 110 in FIGS. 3A to 5), and the elevation wire 160 extends to the outside opposite thereto and is connected to the movable deck (see 150 in FIG. 1) via the above-described direction changing sheave (see 131 in FIG. 1). Since the second sheave 120 faces the first sheave 110 and the elevation wire 160 is located on the opposite side thereto, when the second sheave 120 is pulled toward the first sheave 110 by the drive wire 200, the elevation wire 160 is pulled in the same direction and can elevate the movable deck 150 connected to the elevation wire 160.

As described above, the elevation wire 160 is provided in plurality of elevation wires 160 and connected to the four corners of the movable deck 150, and the elevation wires 160 are gathered at the rear portion of the sliding unit 140 (right side of the drawing and means the opposite side to the second sheave) via the direction changing sheaves 131 that are in contact with the elevation wires, respectively. As a result, all of the plurality of elevation wires 160 are connected to one side of the sliding unit 140 and can be simultaneously pulled when the sliding unit 140 is moved. The elevation wire 160 may be coupled to the body 141 of the sliding unit 140 with an anchor 143.

Meanwhile, the fixing unit 142 may also be arranged in the sliding unit 140. The fixing unit 142 is a structure that restrains or releases the restraint of the sliding unit 140, and through such actions, it can act to selectively make only the second sheave 120 of a specific deck unit movable. The fixing unit 142 may be installed in at least one of the sliding unit 140 and the frame (see 130 in FIGS. 2A and 2B) of the deck unit, and when the sliding unit 140 arrives at the fixing position (it can be a specific position on the sliding rail; since the fixing position can be changed as needed, it does not need to be limited to any fixed position), at least a part can protrude from the sliding unit 140 or from the frame 130 to restrict the movement of the sliding unit 140.

For example, the fixing unit 142 may include the fixing block 142a which is protruded by a driving apparatus and is inserted into the frame 130 from the sliding unit 140 or is inserted into the sliding unit from the frame, and the driving apparatus may be operated by at least one of hydraulic, electric, and magnetic forces. That is, since the protrusion of the fixing unit 142 can be operated by at least one of hydraulic force and/or electric force and/or magnetic force, it can be modified into various forms within this scope.

For example, the fixing unit 142 may drive the fixing block 142a with a hydraulic cylinder, may drive the fixing block 142a with a driving apparatus operated by electric power such as a motor, may drive the fixing block 142a with other structures (e.g., a driving apparatus protruding with a repulsive force by use of a magnetic force using an electromagnet, etc.), or may operate the fixing block by combining these apparatuses or by using a driving apparatus capable of operating the fixing block in another way. The driving apparatus can be variously modified within such possible limits.

In this embodiment, an example in which the fixing unit 142 is installed at the sliding unit 140 will be described. The structure of the fixing unit 142 may be as follows. The fixing unit 142 may include a drive motor 142c configured to drive a pinion gear 142d, a rack bar 142b meshed with the pinion gear 142d and configured to be linearly moved, and the fixing block 142a connected to the rack bar 142b and configured to be inserted into the frame 130 from the sliding unit 140. Besides, sensors 142e for detecting operations of the fixing blocks 142a may also be arranged in the fixing unit 142.

The drive motor 142c may be connected to the central pinion gear 142d to drive the pinion gear 142d. When the pinion gear 142d rotates, the rack bars 142b and the fixing blocks 142a connected to the rack bars 142b move linearly (see the arrows) to protrude outward from the sliding unit 140 or to retract into the sliding unit 140. Therefore, they can protrude from the sliding unit and be inserted into the frame. The sliding unit 140 may be restrained or released by using such a movable protruding structure. For example, in FIG. 3A to 3C described above, the sliding unit 140 may be in a restrained state, and in FIG. 3D, the sliding unit 140 may be in a released state.

In the sliding rail (see 132 in FIGS. 3A to 3D), grooves (not shown) to which the fixing block 142a is penetrated and fixed may be formed (in plurality) at appropriate positions. A plurality of grooves may be formed, and accordingly, a plurality of fixing positions may also be formed at each of which the fixing block 142a is coupled to the corresponding groove and (the sliding unit) is fixed. Since the height of the movable deck changes according to the fixing position of the sliding unit 140, the height of the movable deck can be variously changed by forming a plurality of fixing positions of the sliding unit 140.

Also, although not shown, the fixing unit 142 may be connected to a control unit (not shown) that controls the operation of the fixing block 142a, and the control unit may integrally control the fixing units 142 installed at the plurality of deck units. Therefore, it is possible to selectively operate the fixing unit 142 installed in at least one deck unit 100 among the plurality of deck units under the control of the control unit, and, through this, to selectively restrain or release the sliding unit 140 of the corresponding deck unit.

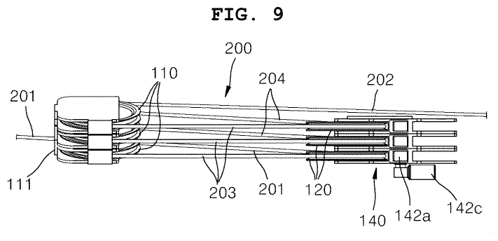

Hereinafter, with reference to FIGS. 7A to 8B, the mutual arrangement of the first sheave and the second sheave installed at the deck unit and the operation of the movable deck by the drive wire will be described in more detail. In addition, with reference to FIG. 9, a modified example of the first sheave and the second sheave will also be described.

FIGS. 7A and 7B are an enlarged top view and a front view of any one deck unit included in the elevation system of FIGS. 2A and 2B, FIGS. 8A and 8B show operational views of the deck unit of FIG. 6, and FIG. 9 shows a modification of the first sheave and the second sheave. Also, in these drawings, it should be noted that the body (see 141 of FIGS. 3A to 3D) of the sliding unit 140 is shown with an imaginary line to reveal the internal structure.

Referring to FIGS. 7A and 7B, it can be seen how the first sheave 110 and the second sheave 120 installed at the deck unit 100 are arranged. The second sheave 120 may be coupled to the sliding unit 140 described above, and the first sheave 110 may be coupled to and fixed to the upper structure of the frame 130.

The drive wire 200 is simultaneously wound around the first sheave 110 and the second sheave 120 and extends to another adjacent deck unit. Preferably, the first sheave 110 and the second sheave 120 may be arranged so that an imaginary line connecting the respective rotational axes thereof is in the same direction as the direction in which the drive wire 200 extends passing through the deck unit 100. The sliding direction of the sliding unit 140 may also be in the same direction. That is, the drive wire 200 may extend parallel to the moving direction of the sliding unit 140.

The first sheave 110 and the second sheave 120 may have the same diameter. In such a case, it would be advantageous to coincide the extension direction of the entire drive wire 200 with the extension direction of the winding portion (for example, it may mean the above-mentioned first section, second section, and third section) of the drive wire 200 wound between the first sheave 110 and the second sheave 120 to keep both in parallel.

Referring to the enlarged view, the second sheave 120 and the elevation wire 160 may be coupled to the both ends of the sliding unit 140, respectively, along an imaginary line connecting the rotational axes of the first sheave 110 and the second sheave 120. The second sheave 120 may be disposed on the inside facing the first sheave 110, and the elevation wire 160 may extend to the outside opposite thereto and be connected to the movable deck 150 via the direction changing sheave 131 described above. That is, the first sheave 110, the second sheave 120, and the distal end of the elevation wire 160 may be placed on a substantially straight line to create the displacement by adjusting the distance between the first sheave 110 and the second sheave 120.

The elevation wires 160 are gathered on the opposite side of the second sheave 120 and are simultaneously pulled when the driving force is provided, so the elevation wires can simultaneously lift the corners of the movable deck 150 via the direction changing sheaves 131, respectively. As described above, the plurality of elevation wires 160 may be distributed from the rear portion of the sliding unit 140 and connected to the corners of the movable deck 150, respectively, by use of the horizontal sheaves 131a formed in the horizontal direction and disposed behind the sliding unit 140, and of the vertical sheaves 131b formed in the vertical direction and disposed above the four corners of the movable deck 150.

Referring to FIGS. 8A and 8B, when the drive wire 200 is pulled by this structure, the movable deck 150 is raised. When the drive wire 200 pulls the second sheave 120 toward the first sheave 110 and the driving force is delivered to the sliding unit 140 connected to the second sheave 120, the elevation wires 160 connected to the sliding unit 140 pull the movable deck 150 upward. Here, the fixing unit 142 is in a state in which the fixing blocks 142a are retracted and the restraint of the sliding unit 140 is released. When the movable deck 150 is raised and reaches the target position, the fixing blocks 142a protrude again to restrain the movement of the sliding unit 140.

Since this structure is a structure in which the second sheave 120 acts as a movable pulley to generate a gain of force, there is an advantage in that a smaller load is burdened to the driver (see 210 in FIGS. 1 to 2B) pulling the drive wire 200. In addition, since it is formed in a structure in which the first sheave 110 and the second sheave 120 are wound with the single drive wire 200, it is structurally simple. Moreover, since it is possible to allow the second sheave 120 to move or prevent the second sheave from moving only by the operation of the fixing unit 142, there is an advantage in that the operation of the movable deck 150 through it is also simplified.

When the above-described operation is performed in a reverse order (i.e., when the restraint of the fixing unit 142 is released, the drive wire is slowly released to relieve tension, and the sliding unit is moved back), the distance between the first sheave 110 and the second sheave 120 can be increased to the original, thereby lowering the movable deck 150 to its original position.

Meanwhile, the first sheave 110 and the second sheave 120 may be modified, as needed, to the form illustrated in FIG. 9 or the like. That is, although the first sheave 110 and the second sheave 120 have been described with reference to a single sheave in this embodiment, it is also possible to provide a plurality of sheaves in a multi-layer form by arranging respective sheaves one above another as needed. For example, as shown in FIG. 9, at least one of the first sheave 110 and the second sheave 120 may be provided in the multi-layer form by arranging a plurality of sheaves one above another with their axes on the same rotational axis. In addition, the drive wire 200 may be simultaneously wound between the first sheave 110 and the second sheave 120 a plurality of times and extend to an adjacent deck unit. That is, by repeatedly applying the winding structure of FIGS. 3A to 3D to the first sheave 110 and the second sheave 120 in which a plurality of sheaves are arranged in the multi-layer form, the drive wire 200 is wound several times between the first sheave 110 and the second sheave 120, thereby enabling the amplification of the effect (gain of force) of the movable pulley.

For example, in the modified example of FIG. 9, the drive wire 200 may be simultaneously wound multiple times between the first sheave 110 with sheaves arranged in a three-layered form and the second sheaves 120 with sheaves arranged in a three-layered form and may extend to an adjacent deck unit. For example, the drive wire 200 may be bent again after the first section 201 is wound around the second sheave 120 at the lowest level, and may also be wound around the first sheave 110 at the lowest level. In this way, after being simultaneously wound around the first sheave 110 and the second sheave 120 at the lowest level, it may be repeated for the first sheave 110 and the second sheave 120 above them and again repeated for the first sheave 110 and the second sheave 120 at the highest level, and then the drive wire may pass past the second sheave 120 at the highest level and enter the next deck unit. Accordingly, the second section 202 may be formed from the first sheave 110 at the highest level.

Due to this, the third section 203 in which the drive wire contacts the first sheave 110 and the second sheave 120 at the same time may be formed in plurality corresponding to the number of the sheaves arranged in the multi-layer form, and transition sections 204 connecting between sheaves of different heights may be added to connect between the sheaves arranged in the multi-layer form. Since this structure is a structure in which the single drive wire 200 is wound around a plurality of first sheaves 110 and a plurality of second sheaves 120 several times in a zigzag form and exits, the number of movable pulleys (that is, the second sheave) is increased to exert the effect of amplifying the gain of force. Therefore, it is possible to operate the movable deck more effectively without straining the drive system. In this way, the movable deck 150 can be elevated by winding the drive wire 200 around the first sheave 110 and the second sheave 120 and moving the second sheave 120.

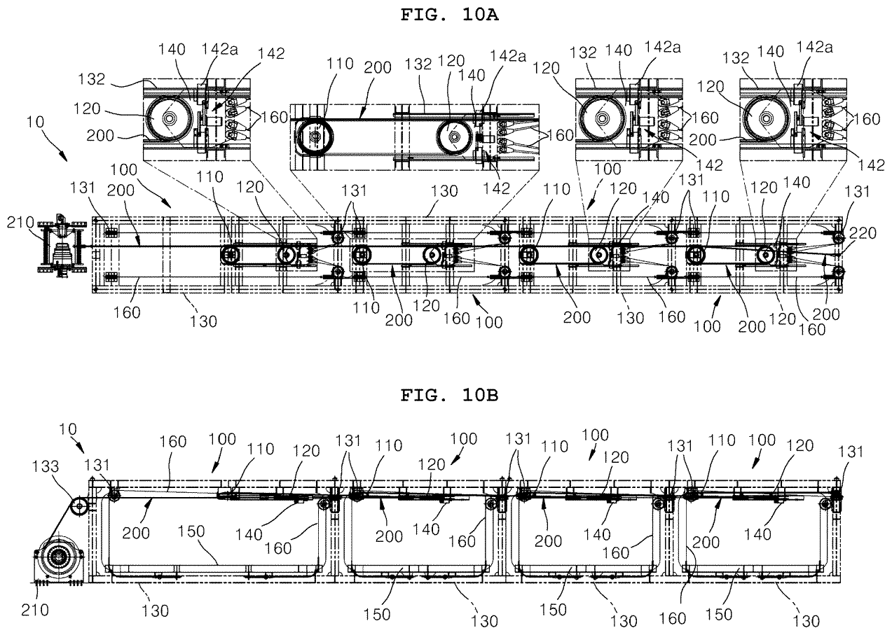

FIGS. 10A to 11B are operational views of the entire elevation system of FIGS. 2A and 2B.

The operation of the deck unit 100 may be selectively performed with respect to the entire elevation system 10 shown in FIGS. 10A and 10B. The following manipulations are possible by use of the above-described fixing unit 142. For example, as shown in the enlarged view of FIGS. 10A and 10B, when all of the fixing units 142 installed at the plurality of deck units 100 are in the protruding state (the fixing blocks 142a protrude) and restrain the sliding units 140, the second sheaves 120 of all deck units 100 cannot move, so the operation of all deck units 100 is stopped.

However, as shown in the enlarged view of FIGS. 11A and 11B, when only the fixing unit 142 installed at any one deck unit 100′ is selected and the restraint of the sliding unit 140 is released (only the fixing blocks 142a of the corresponding deck unit are retracted), the second sheave 120 of only the corresponding deck unit 100′ moves, so the movable deck 150 of only the specific deck unit 100′ can be raised. That is, even if the entire drive wire 200 is pulled, the first sheave 110 and the second sheave 120 of the other deck units 100 in which the second sheaves 120 are restrained act only as fixed pulleys, so they only serve to deliver tension to the second sheave 120 of the deck unit 100′ in which restraint is released. Accordingly, the position of the second sheave 120 of only the specific deck unit 100′ in which restraint is released is selectively changed.

Since this structure can be applied to one or a plurality of deck units by control such as by the above-described control unit (not shown), at least any one of the plurality of deck units 100 can be selectively operated with the single drive wire 200, and it is also possible to simultaneously operate all the deck units 100 of the elevation system 10 as needed.

That is, according to the present disclosure, since any one or two or more or all of the second sheaves 120 of the deck units 100 can be selected and its position or their positions can be changed, the movable deck 150 of any one of the plurality of deck units 100 is elevated or the plurality of movable decks 150 of the plurality of deck units are simultaneously elevated depending on the number of the second sheaves 120 whose position is variable. Therefore, the positions of the movable decks 150 of the different deck units 100 may be sequentially adjusted, or the positions of the movable decks 150 of all the deck units 100 may be simultaneously adjusted to change the heights at once. Therefore, it is possible to properly adjust the movable deck 150 in various ways. In this way, the elevation system 10 can be operated in a very efficient manner.

Hereinafter, a vessel including an elevation system according to an embodiment of the present disclosure will be described in detail with reference to FIG. 12. Since the elevation system of the present disclosure has been described in detail above, a repetitive description thereof will be omitted and a difference from the above-described embodiments will be mainly described.

FIG. 12 is a conceptual diagram of a vessel including an elevation system according to an embodiment of the present disclosure.

Referring to FIG. 12, a vessel 1 of the present disclosure includes a hull 11 and the elevation system 10 installed inside the hull 11. The hull 11 may be, for example, a hull 11 of a vehicle carrier or the like which can be used to ship vehicles. The elevation system 10 of the present disclosure can be installed and used in the internal loading space of the hull 11.

Since the number of the deck units 100, which constitute the elevation system 10, can be increased as needed with substantially the same structure, the number of deck units 100 may be increased in consideration of the length of the hull 11 and the size of the loading space. The drawing shows only a part thereof.

When the elevation system 10 is applied to a vessel or the like, the frame 130 may directly utilize the hull 11 as described above. That is, the frame 130 can be configured with a hull structure such as a frame formed in the hull 11, and therefore does not need to be installed separately. In this way, the elevation system 10 of the present disclosure can be easily constructed by using the structure formed on the hull 11 as the frame 130.

The elevation systems 10 may be stacked vertically when the hull 11 has a multi-layer shipment deck. Also, the drawing shows a part thereof, and the number of stacked elevation systems 10 can be increased as needed. In this way, by applying the above-described elevation system 10 to the inside of the hull 11, it is possible to selectively adjust the height of the movable deck, thereby carrying vehicles of various sizes. The vessel 1 with the elevation system 10 installed therein in this way can also be provided.

While the embodiments of the present disclosure have been described above with reference to the accompanying drawings, those of ordinary skill in the art to which the present disclosure pertains will appreciate that the present disclosure may be implemented in other specific forms without changing the technical idea or essential features thereof. Accordingly, it should be understood that the embodiments described above are illustrative in all respects and not restrictive.

According to the present disclosure, a deck on which a vehicle or the like is loaded can be raised and lowered in an efficient manner. With a structure that properly distributes the load of the deck, it is possible to reduce the load burdened to the driver, and a plurality of decks separated from each other can be operated very efficiently in such a way. Additionally, it is possible to selectively operate a plurality of decks by simply and efficiently selecting an elevating deck, and it is also advantageous in operating one or a plurality of decks at once. Therefore, advantages can be obtained from processes such as vehicle shipping or the like, compared to the related art.

Further, there is an advantage in that, with the power transmission structure using a wire, the arrangement of the deck unit is relatively free, so it can be installed in vessels of various shapes and can be easily applied to parking systems, warehouses, loading boxes or the like.

While the present invention has been described with respect to the specific embodiments, it will be apparent to those skilled in the art that various changes and modifications may be made without departing from the spirit and scope of the invention as defined in the following claims.

What is claimed is:

1. An elevation system comprising:
a plurality of deck units, each of which including:
a frame,
a movable deck coupled to the frame so as to be movable in a vertical direction,
a sliding unit coupled to the frame so as to be movable in a horizontal direction, and
a plurality of elevation wires, each of which has one end connected to the movable deck and the other end coupled to the sliding unit via a direction changing sheave installed at the frame;
a first sheave installed at each of the plurality of deck units and fixed to the frame;
a second sheave installed at each of the plurality of deck units and coupled to the sliding unit, so that a distance between the first sheave and the second sheave is adjusted as the sliding unit moves;
a drive wire extending through the plurality of deck units and simultaneously wound around the first sheave and the second sheave of each of the plurality of deck units to deliver a driving force to the sliding unit; and
a driver configured to pull the drive wire to cause the sliding unit to be slidably moved.

2. The elevation system of claim 1, further comprising a fixing unit installed at the deck unit and configured to restrain the sliding unit or release restraint of the sliding unit to selectively cause the position of the second sheave of only at least one of the plurality of deck units to be variable.

3. The elevation system of claim 2, wherein the fixing unit is installed in at least one of the sliding unit and the frame, and, when the sliding unit arrives at a fixing position, at least a part is configured to protrude from the sliding unit or the frame to restrict a movement of the sliding unit.

4. The elevation system of claim 3, wherein the fixing unit includes a fixing block which is protruded by a driving apparatus and is inserted into the frame from the sliding unit or is inserted into the sliding unit from the frame, and the driving apparatus is operated by at least one of hydraulic force, electric force, and magnetic force.

5. The elevation system of claim 4, wherein the fixing unit includes a drive motor configured to drive a pinion gear, a rack bar meshed with the pinion gear to be linearly moved, and the fixing block connected to the rack bar and configured to be inserted into the frame from the sliding unit or into the sliding unit from the frame.

6. The elevation system of claim 1, wherein the first sheave and the second sheave are arranged so that an imaginary line connecting respective rotational axes thereof is in the same direction as a direction in which the drive wire extends passing through the deck unit.

7. The elevation system of claim 6, wherein the drive wire extends parallel to a moving direction of the sliding unit.

8. The elevation system of claim 6, wherein the first sheave and the second sheave have the same diameter.

9. The elevation system of claim 6, wherein the second sheave and the elevation wire are coupled to both ends of the sliding unit along the imaginary line, respectively, and the second sheave is disposed on an inside facing the first sheave, and the elevation wire extends to the outside and is connected to the movable deck via the direction changing sheave.

10. The elevation system of claim 1, wherein the drive wire includes:
a first section in which the drive wire comes into any one deck unit from the driver or an adjacent deck unit and contacts any one of the first sheave and the second sheave;
a second section in which the drive wire contacts the other one of the first sheave and the second sheave and extends to another adjacent deck unit; and
a third section in which the drive wire contacts the first sheave and the second sheave at the same time.

11. The elevation system of claim 10, wherein any one of the first sheave and the second sheave is arranged to be twisted relative to the other thereof, so that the first section and the second section are at different heights.

12. The elevation system of claim 1, wherein at least one of the first sheave and the second sheave is provided in a multi-layer form by arranging a plurality of sheaves one above another with their axes on the same rotational axis.

13. The elevation system of claim 1, wherein the drive wire is simultaneously wound between the first sheave and the second sheave a plurality of times and extends to an adjacent deck unit.

14. The elevation system of claim 2, wherein the movable deck of any one of the plurality of deck units is elevated or the plurality of movable decks of the plurality of deck units are simultaneously elevated depending on a number of the second sheaves whose position is variable.

15. A vessel comprising:
a hull; and
an elevation system of claim 1 installed inside the hull.
